(19) United States
(12) Patent Application Publication
(10) Pub. No.: US 2006/0101072 A1
(43) Pub. Date: May 11, 2006

(54) System and method for interpreting scan data

(75) Inventors: Frederick D. Busche, Highland Village, TX (US); Robert L. Angell, Salt Lake City, UT (US); Alexander D. Zekulin, (US)

Correspondence Address: HOFFMAN, WARNICK & D'ALESSANDRO LLC, 75 STATE ST, 14 FL, ALBANY, NY, 12207, US

(73) Assignee: International Business Machines Corproation, Armonk, NY (US)

(21) Appl. No.: 10/969,819

(22) Filed: Oct. 21, 2004

(51) Int. Cl. G06F 17/00

(52) U.S. Cl. 707/104.1

(57) ABSTRACT

A system, method and program product for interpreting scan data. A system is provided that includes: an input system for inputting scan data and associated subject data; a geographic information system (GIS) for generating spatial data from the scan data and allows for the mathematical integration of layered spatial data, and for calculating image attributes from the spatial data; a relational database for storing integrated attribute data from a plurality of subjects, wherein the integrated attribute data includes subject data and image attributes; and an analysis tool for interpreting image attributes of inputted scan data by identifying similar image attributes from the integrated attribute data stored in the relational database.

### BACKGROUND OF THE INVENTION

1. Technical Field

The present invention relates generally to interpreting scanned medical images, and more specifically relates to a system and method of using a spatial analysis technique to allow for the interpretation of scanned data maintained in a relational database.

2. Related Art

In fields such as the medical industry, interpretation of scanned data is done primarily by experts who visually review images. For example, MRI (magnetic resonance images) and X-rays are typically read by radiologists, who then report their findings back to the doctor responsible for treating the patient. The treating doctor in some instances may compare the results to previous scanned data for the patient in order to further interpret the patient's condition.

Unfortunately, there is little or no automation or integration of data collected in this manner. For example, doctors do not generally have ready access to information about similarly situated patients, i.e., those having similar medical conditions and attributes (e.g., age, weight, medical history, etc.), their diagnosis, treatments and results. Instead, doctors must rely largely on their own personal expertise and knowledge to interpret scanned data.

Accordingly, a need exists for a system that can automatically analyze and integrate data captured from a scan and calibrate the image data such that numerical methods can be used to monitor differing irregularities in organs and disease attributes such that size, can be accurately determined.

### SUMMARY OF THE INVENTION

The present invention addresses the above-mentioned problems, as well as others, by providing an automated system and method for interpreting scan data. In a first aspect, the invention provides a system for interpreting scan data, comprising: an input system for inputting scan data and associated subject data; a geographic information system (GIS) for generating spatial data from the scan data, and for calculating image attributes from the spatial data; a relational database for storing integrated attribute data from a plurality of subjects, wherein the integrated attribute data includes subject data and image attributes; and an analysis tool for interpreting image attributes of inputted scan data by identifying similar image attributes from the integrated attribute data stored in the relational database.

In a second aspect, the invention provides a program product stored on a recordable medium for interpreting scan data, comprising: means for inputting scan data and associated subject data; means for generating spatial data from the scan data, and for calculating image attributes from the spatial data; means for storing integrated attribute data from a plurality of subjects in a relational database, wherein the integrated attribute data includes subject data and image attributes; and means for interpreting image attributes of inputted scan data by identifying similar image attributes from the integrated attribute data stored in the relational database.

In a third aspect, the invention provides a method for interpreting scan data, comprising: providing a relational database having integrated attribute data from a plurality of subjects, wherein the integrated attribute data includes subject data and image attributes; inputting scan data and associated subject data; generating spatial data from the scan data; calculating image attributes from the spatial data; and interpreting image attributes of the inputted scan data by identifying similar image attributes from the integrated attribute data stored in the relational database.

In a fourth aspect, the invention provides a method for deploying an application for interpreting scan data, comprising: providing a computer infrastructure being operable to: input scan data and associated subject data; generate spatial data from the scan data; calculate image attributes from the spatial data; store integrated attribute data from a plurality of subjects in a relational database, wherein the integrated attribute data includes subject data and image attributes; and interpret image attributes of inputted scan data by identifying similar image attributes from the integrated attribute data stored in the relational database.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an architecture for implementing a scan interpretation system in accordance with the present invention.

FIG. 2 depicts a business integrated attribute data record in accordance with the present invention.

### DETAILED DESCRIPTION OF THE INVENTION

The analytical techniques described below enhance the expert based visual interpretation of scan data by allowing the analyst of the results to not only interpret the image by using his previous experience, but also be able to use analytical techniques to develop mathematical models that allow for comparison to previously obtained data on the same subject or comparison between subjects that may have similar conditions. This invention also allows for the use of data mining techniques as well as statistics to be used on the scanned data to compliment other data that is available on a patient. By comparing images analytically with data previously obtained on the same subject, progress of abnormalities can be tracked. By comparing images analytically from different subjects and mating that analysis with other data on many subjects where known outcomes have occurred an assessment of the probability of certain abnormalities that have resulted in a diagnosed result can be made.

This second technique, comparing images analytically from different subjects, allows for a final diagnosis to be obtained that is more accurate and therefore will lead to more successful corrective final outcomes to be realized as a result of more appropriate treatment scenarios because more data is being integrated to diagnose the problem. Based upon the utilization of not only the patterns that appear in the image, but also allowing for the measurement of the data from that image such that assessment of potential growth rates of tumors, restriction of arteries, uptake of drugs, fluid passage speeds, fluid paths, speed of recovery, treatment efficacies, etc., can be estimated. This gives the analyst a more analytical means that can be used to supplement experience such that diagnoses associated with many kinds of illnesses or recoveries can be more accurately determined.

The invention provides the described functionality by adapting a Geographic Information System (GIS), normally used as a means of spatially analyzing things in two or three dimensions with reference to the earth's geographic grid, which is used in this invention to index the human body such that analytical assessment of scanned data can be rectified. GIS provides well known techniques for providing spatial analysis of image data, and has heretofore been used primarily for analyzing geographic features. GIS software, such as that sold by ESRI™, generates a grid pattern on the features being studied, and thereby allows spatial analysis to be performed. GIS is computer software that links geographic information (where things are) with descriptive information (what things are). Unlike a flat image, where “what you see is what you get,” GIS software can present many layers of different information. All the information, e.g., where the point is located, how long an attribute is, the area or volume of an attribute, etc., is stored as layers in a digital format. Each layer represents a particular feature of a mapping. One feature could be made up of all the blood vessels in a particular area. Another feature could represent all the lymph nodes in the same area. Yet another could represent all the bone mass. These features can be laid on top of one another, creating a stack of information about the same area. Each layer can be turned off and on, as necessary in order control the amount of information about a desired area. It also provides for the mathematical integration of planar data. For example, if one has an abnormal color associated with an organ along with an abnormal texture to the same organ, the degree of both abnormalities could be added together to give a total measurement of abnormality over the surface of that organ.

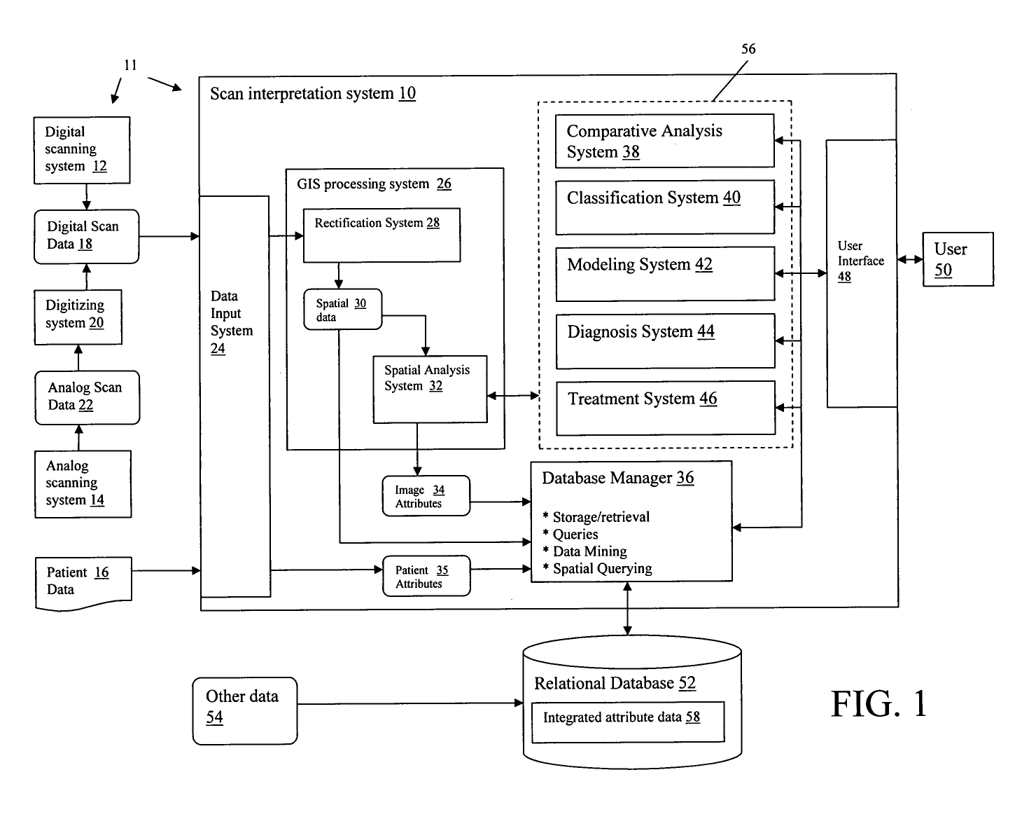

FIG. 1 depicts an illustrative architecture 11 for implementing a GIS based scan interpretation system 10. Scan interpretation system 10 generally comprises: (1) a data input system 24 for inputting and processing both digital 18 or analog 22 scan data and patient data 16; (2) a GIS processing system 26; (3) a relational database 52 and database manager 36 for storing and retrieving data; and (4) a set of analysis tools 56 for analyzing data stored in the relational database. It should be understood that while the invention is described with reference to analyzing medical scans and related patient data, the present invention could be utilized in any application where scan data of a subject needs to be interpreted and integrated with other data.

It should be appreciated that scan analysis system 10 of the present invention could be carried out on a stand-alone computer system, or over a network such as the Internet, a local area network (LAN), a wide area network (WAN), a virtual private network (VPN), etc. Suitable computer systems may include a mainframe, a desktop computer, a laptop computer, a workstation, a hand held device, a client, a server, etc. In any event, the computer system may generally comprise, e.g., a processing unit, memory, a bus, input/output (I/O) interfaces, external devices/resources and a storage unit. The processing unit may comprise a single processing unit, or processors distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, similar to processing unit, memory may reside at a single physical location, comprising one or more types of data storage, or be distributed across a plurality of physical systems in various forms.

I/O interfaces may comprise any system for exchanging information to/from an external source. External devices/resources may comprise any known type of external device, including a scanner, a storage device, a network connection, speakers, a hand-held device, a keyboard, a mouse, a voice recognition system, a speech output system, a printer, a monitor/display, a facsimile, a pager, etc.

Relational database 52 may comprise any type of storage unit capable of providing storage for information under the present invention. As such, the storage unit could include one or more storage devices, such as a magnetic disk drive or an optical disk drive. Moreover, the storage unit may include data distributed across, for example, a local area network (LAN), wide area network (WAN) or a storage area network (SAN).

Thus, it should also be understood that while the invention is described as a single integrated architecture 11, the invention could be implemented in a distributed fashion where the components and subsystems do not necessarily reside at the same physical location.

As can be seen in FIG. 1, digital scan data 18 is obtained from a digital scanning system 12, such as an MRI, or from a digitizing system 20 that digitizes analog scan data 22 from an analog scanning system 14, such as an x-ray film. Digital scan data 18, as well as patient data 16 are inputted to data input system 24, e.g., after a scan is performed on a patient. Patient data 16, such as name, age, sex, medical history, weight, diagnosis data, treatment information, etc., are converted into a set of patient attributes 35 suitable for storage in relational database 52 by database manager 36. Likewise, GIS processing system 26 processes the digital scan data 26 to create either or both of a set of image attributes 34 and spatial data 30 suitable for storage in relational database 52 by database manager 36.

GIS processing system 26 includes a rectification system 28 that rectifies the digital scan data 18 over a grid of known dimensions in order to generate spatial data 28. Once this rectification has occurred, a standard spatial analysis of relationships of data points can be performed by spatial analysis system 32. These might include measurements of the volume or area of an abnormality, the acceleration of a liquid that might be expected due to a restriction on a passageway which would result in a transit time, the change in intensity of the pixels in an image, or possibly the rate at which an uptake of a chemical or medicine might be expected to take, etc. If the digital scan data 18 is obtained in layers, then the scanned images must be rectified over a three dimensional grid rather than a two dimensional grid.

The image attributes 34 obtained by using GIS processing system 26 can then be integrated with the patient attributes 35 by database manager 36 to be stored in relational database 52. Thus, each time the patient has a scan, updated attributes 34, 35 can be added to the previously collected attributes 34, 35 already stored in relational database 52. The result is an integrated collection of scan and patient attribute data referred to herein as “integrated attribute data 58.” Moreover, as more and more data from different patients are collected over time, a readily searchable knowledge base of integrated attribute data 58 is formed, thereby allowing patients having similar medical conditions or attributes to be easily identified and studied.

In addition, the complete set of spatial data 30 generated by rectification system 28 may be stored in the relational database 52 as part of the integrated attribute data 58. Spatial analysis system 32 can then be run dynamically as needed on the spatial data 30 by one of the analysis tools 56 (described below) to generate any necessary image attributes 34.

In one illustrative embodiment, a collection of images are captured as a video or motion picture. Once captured, movement can be calibrated such that velocities and accelerations of liquids or gases can be measured. These changes in velocities or an acceleration then can be used to ascertain where changes in volume of gas or liquid moving past a point can be determined.

In order to fully exploit integrated attribute data 58 stored in relational database 52, a set of analysis tools 56 are provided. Analysis tools 56 are made available to an end user 50 via a user interface 48, which may for example comprise a web browser or other type of graphical user interface. Analysis tools 56 may for example perform data mining operations on relational database 52 using known OLAP (On Line Analytical Processing) techniques utilizing, e.g., SQL queries. Note that tools 56 depicted in FIG. 1 are shown for illustrative purposes only, and are not meant to depict all of the possible types of tools that can be utilized to access and analyze relational database 52. Moreover, analysis tools 56 may be integrated together to perform a particular function, e.g., calculate probabilities of success for a treatment on a patient having an inputted set of image attributes.

Analysis tools 56 include a comparative analysis system 38 that allows integrated attribute data 58 from different patients to be compared and analyzed. For example, patients who display similar image attributes 34 relating to a particular medical condition can be compared to a current patient to analyze a likely prognosis of the condition, determine a diagnosis, outline treatment options, etc. In the case where spatial data 30 is stored in relational database 52, SQL queries enhanced by the ability to utilize spatial querying techniques of a database could be used to identify similar image attributes 34.

Classification system 40 may be utilized to classify image and/or patient attributes as relating to a particular condition. For example, classification system 40 might classify males, over the age of 55 who smoke and present certain image attributes 34 as being members of a group having a predefined medical condition. Then, by interacting with the other tools, classification system might give the probability of different outcomes of the medical condition for a patient, which could then be considered by the user 50 to enhance his or her expert opinion with an analytically determined diagnosis. Another classification algorithm might classify dosage information collected from members of a similar group and allow for the estimation of dosage rates for a cure, or drug combinations that might be the most successful for a cure.

Modeling system 42 could be utilized to, e.g., predict outcomes, identify community patterns, calculate probabilities, facilitate classifications, etc. Diagnosis system 44 may be utilized to diagnose a condition of an individual based on the individual's image attributes 34 and/or patient attributes 35, as well as integrated attribute data 58 of other individuals stored in relational database 52. Treatment system 46 may be utilized to prescribe a treatment or set of treatment options in view of the diagnosis, the individual's image attributes 34, patient attributes 35, and/or integrated attribute data 58 of other individuals stored in relational database 52.

Another data mining analysis example utilizing analysis tools 56 might be one that looks at the comparison of the integrated attribute data 58 in relational database 52 with other digital data such as EKG data to find similar patterns in the EKG that are coincidental with certain scanned abnormalities, such as those detected using a sonogram. The result is a more robust analysis of these abnormalities before more invasive exploratory methods are utilized. Data mining might also be used as a means of comparing a digitally rectified image plus GIS data that would allow for the integration of image characteristics with other demographic data and genetic data to look at clustering of groups that might have either similar genetics, treatment protocols, or demographic characteristics. This cumulative clustered data then might be fed back into the GIS system to look at the adding of spatial layers that could see overlaps of surface characteristics of an irregularity that might link shape or surface information that is similar between different clustered groups and thereby categorize the image data by the supporting demographic, treatment or genetic data.

By combining integrated attribute data 58 with other data, such as demographics, sex, etc., more general relationships that occur geographically might be discovered that could be used to look at patterns that might be present in a community setting. This could be used as an additional means for the understanding of epidemic spreading behavior.

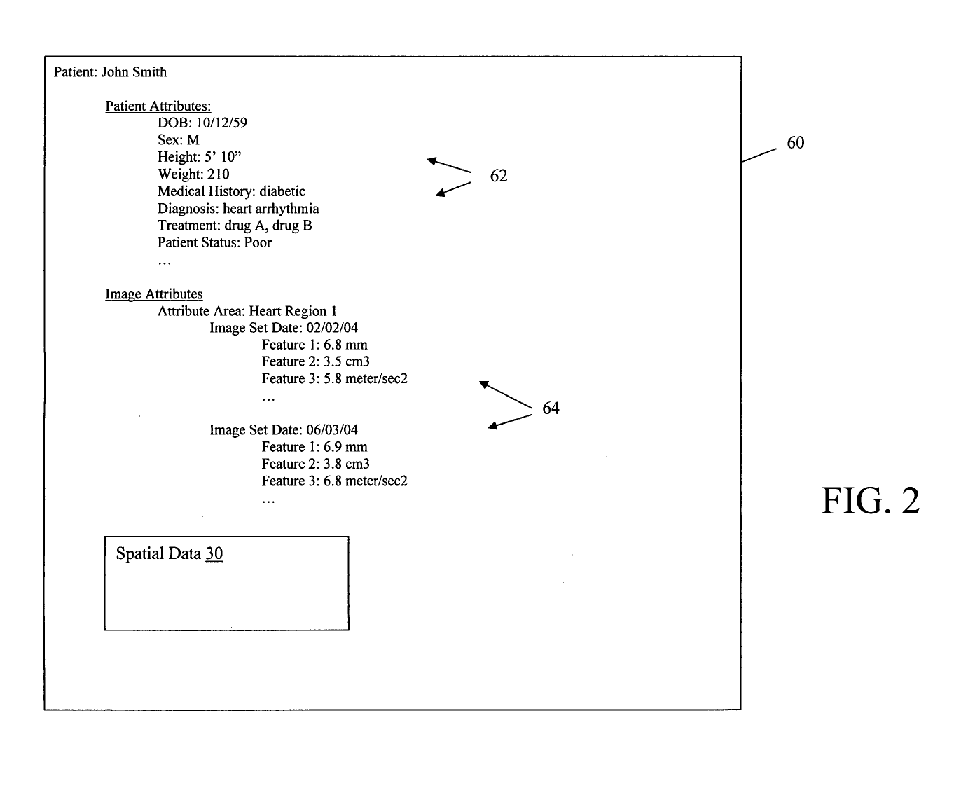

Referring now to FIG. 2, a simplified illustration of an integrated attribute record 60 for the patient John Smith is shown. As can be seen, integrated attribute record 60 includes a set of patient attributes 62, a set of image attributes 64, and one or more sets of spatial data 30. Obviously, the amount and type of information contained in the record 60 will vary depending on the particular application. Because the data is stored in a relational database, an end user or system tool is able to search on any combination of the fields to collect a set of data records that might be relevant to the particular situation. Additionally, spatial querying may be utilized to locate particular image attributes in a dynamic fashion from spatial data 30. For example, a search might be constructed to locate all males over the age of 50 who have been diagnosed with a heart arrhythmia and have a blood flow of greater than 5.5 meters/seconds² through feature 3 of the heart. From there, records may be grouped based on the type of prescribed treatment and the resulting condition of the patient.

It should be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

It should also be appreciated that the teachings of the present invention can be offered as a business method on a subscription or fee basis. For example, a computer system could be created, maintained, supported, and/or deployed by a service provider that offers the functions described herein for customers.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for interpreting scan data, comprising:
an input system for inputting scan data and associated subject data;
a geographic information system (GIS) for generating spatial data from the scan data, and for calculating image attributes from the spatial data;
a relational database for storing integrated attribute data from a plurality of subjects, wherein the integrated attribute data includes subject data and image attributes; and
an analysis tool for interpreting image attributes of inputted scan data by identifying similar image attributes from the integrated attribute data stored in the relational database.

2. The system of claim 1, wherein the scan data comprises a medical image and the associated subject data comprises patient attributes.

3. The system of claim 1, wherein the GIS includes a rectification system for generating a spatial grid onto the scan data.

4. The system of claim 1, wherein the image attributes include measurements selected from the group consisting of: length of a feature, area of a feature, volume of a feature, fluid velocity, and fluid acceleration.

5. The system of claim 1, wherein the integrated attribute data further includes the spatial data, and wherein the relational database includes a system for querying spatial data stored in the relation database.

6. The system of claim 1, wherein the analysis tool includes a comparative analysis system for comparing image attributes.

7. The system of claim 1, wherein the analysis tool includes a classification system for classifying image attributes from different subjects.

8. The system of claim 1, wherein the analysis tool includes a modeling system for modeling predictive outcomes by analyzing sets of integrated attribute data.

9. The system of claim 2, wherein the analysis tool includes a diagnosis system that generates a diagnosis of a patient attribute.

10. The system of claim 2, wherein the analysis tool includes a treatment system for providing a treatment protocol for a patient attribute.

11. A program product stored on a recordable medium for interpreting scan data, comprising:
means for inputting scan data and associated subject data;
means for generating spatial data from the scan data, and for calculating image attributes from the spatial data;
means for storing integrated attribute data from a plurality of subjects in a relational database, wherein the integrated attribute data includes subject data and image attributes; and
means for interpreting image attributes of inputted scan data by identifying similar image attributes from the integrated attribute data stored in the relational database.

12. The program product of claim 11, wherein the scan data comprises a medical image and the associated subject data comprises patient attributes.

13. The program product of claim 11, wherein the spatial data is generated with a geographic information system (GIS) that provides a spatial grid onto the scan data.

14. The program product claim 11, wherein the image attributes include measurements selected from the group consisting of: length of a feature, area of a feature, volume of a feature, fluid velocity, and fluid acceleration.

15. The program product of claim 11, wherein the integrated attribute data further includes the spatial data, and wherein the storing means includes means for querying spatial data stored in the relation database.

16. The program product of claim 11, wherein the interpreting means includes a tool selected from the group consisting of: means for comparing image attributes; means for classifying image attributes from different subjects; means for modeling predictive outcomes by analyzing sets of integrated attribute data; means for providing a diagnosis of an image attribute; and means for providing a treatment protocol for an image attribute.

17. A method for interpreting scan data, comprising:
providing a relational database having integrated attribute data from a plurality of subjects, wherein the integrated attribute data includes subject data and image attributes;
inputting scan data and associated subject data;
generating spatial data from the scan data;
calculating image attributes from the spatial data; and
interpreting image attributes of the inputted scan data by identifying similar image attributes from the integrated attribute data stored in the relational database.

18. The method of claim 17, wherein the scan data comprises a medical image and the associated subject data comprises patient attributes.

19. The method of claim 17, wherein the spatial data and image attributes are generated with a geographic information system (GIS) that creates a spatial grid onto the scan data.

20. The method of claim 17, wherein the image attributes include measurements selected from the group consisting of: length of a feature, area of a feature, volume of a feature, fluid velocity, and fluid acceleration.

21. The method of claim 17, wherein the integrated attribute data further includes the spatial data, and wherein the step of interpreting image attributes includes querying spatial data stored in the relation database.

22. The method of claim 17, wherein the interpreting step includes a step selected from the group consisting of: comparing image attributes; classifying image attributes from different subjects; modeling predictive outcomes by analyzing sets of integrated attribute data; providing a diagnosis of an image attribute; and providing a treatment protocol for an image attribute.

23. A method for deploying an application for interpreting scan data, comprising:
providing a computer infrastructure being operable to:
input scan data and associated subject data;
generate spatial data from the scan data;
calculate image attributes from the spatial data;
store integrated attribute data from a plurality of subjects in a relational database,
wherein the integrated attribute data includes subject data and image attributes; and
interpret image attributes of inputted scan data by identifying similar image attributes from the integrated attribute data stored in the relational database.
